(19) United States
(12) Patent Application Publication
(10) Pub. No.: US 2004/0112492 A1
(43) Pub. Date: Jun. 17, 2004

(54) Tire for inter-city buses and motor coaches

(76) Inventor: John Kotanides JR., Canton, OH (US)

Correspondence Address: THOMPSON HINE L.L.P., 2000 COURTHOUSE PLAZA , N.E., 10 WEST SECOND STREET, DAYTON, OH, 45402, US

(21) Appl. No.: 10/317,576

(22) Filed: Dec. 12, 2002

(51) Int. Cl. B60C 11/03

(52) U.S. Cl. 152/209.1; 152/209.18

(57) ABSTRACT

A pneumatic tire for inter-city buses and motor coaches having improved handling characteristics and high mileage durability. The tire has a footprint shape factor (FSF) in the range of about 1.13-1.15, a drop off factor (DOF) in the range of about 1.10-1.20, and a tread arc width in the range of about 9.6-9.9 inches. The tire has a substantially rounded footprint. Pressure concentrations in the center and shoulder regions of the tire are minimized, reducing temperature rise, hydroplaning and rolling resistance while improving durability and wet traction.

### FIELD

This invention relates to pneumatic tires for highway usage on inter-city buses and motor coaches.

### BACKGROUND OF THE INVENTION

A number of functional considerations influence tire design. For ideal handling, a tire could be composed entirely of circumferential grooves to prevent side slip. For optimum braking and acceleration, a tire could be composed entirely of lateral grooves to provide traction. An ideal low-noise tire would contain no pattern at all since lateral grooves create a noisy tire. In practice, tire designs incorporate a variety of complex patterns utilizing combinations of cuts and grooves to achieve a mix of performance characteristics tailored for the intended operating environment. For example, a tire designed for off-road use such as with all-terrain vehicles may utilize a tread design optimized to increase traction and reduce side-slip. In contrast, tires designed for passenger automobiles have high-speed handling and low-noise performance criteria.

Tires designed for highway use on inter-city buses and motor coaches also have a defined set of design goals. Desired attributes for this type of tire are long wearable tread life (“durability”), reduced rolling resistance, low tendency for hydroplaning, high wet traction, good handling characteristics at high speed, and low noise. Prior art tires for inter-city buses and motor coaches incorporate many of these characteristics. In particular, prior art tires offer durability for high-mileage operation through the use of a stiffer tread compound, increased tread arc width, and increased wearable tread rubber volume. However, there is a penalty in manufacturing cost due to the additional material expense. The additional rubber also adds to the weight of the tire, adversely affecting the vehicle's fuel economy. There is a need for a tire that provides high-mileage durability without the cost and weight of additional wearable rubber.

### SUMMARY

The present invention provides a tire having a tread design with an improved footprint shape such that the pressure applied to the tread is more evenly distributed. The tread design has a specified range of tread arc width, footprint shape factor, and drop off factor values to produce a rounded footprint design. Concentrated regions of higher pressure are minimized, reducing heat buildup that can accelerate tread wear and reduce tire life. The increased tread durability allows the tire to be produced with less wearable rubber, reducing tire weight and material cost. The present invention also offers reduced rolling resistance and lessened tendency for hydroplaning while providing increased traction on wet surfaces.

### DEFINITIONS

“Axial” and “axially” means the lines or directions that are parallel to the axis of rotation of the tire.

“Carcass” means the tire structure apart from the belt structure, tread, undertread, and sidewall rubber over the plies, but including the beads.

“Equatorial Plane” (“EP”) means the plane perpendicular to the tire's axis of rotation and passing through the center of its tread.

“Footprint” means the area of contact of the tire tread with a flat surface at zero speed and under design load and pressure.

“Footprint Shape Factor” is defined as the maximum circumferential extent of the tire's footprint at the centerplane of the tire's footprint width divided by the circumferential extent of the footprint measured at 35% of the distance from the centerplane toward a shoulder of the footprint.

“Hydroplaning” refers to a condition wherein a tire in motion loses traction during wet pavement conditions because the tire is not in contact with the surface. The tire is in contact only with a film of liquid on the surface.

“Inner” means toward the inside of the tire with reference to the tire's equatorial plane.

“NSS” refers generally to the non-serial side of the tire. That is, the side of the tire not having the serial number embossed on the sidewall. This notation is used with the notation “SS” to distinguish the sides of the tire due to its inherent symmetry.

“Outer” means toward the tire's exterior with reference to the tire's equatorial plane.

“Pneumatic tire” means a laminated mechanical device of generally toroidal shape (usually an open-torus) having beads and a tread and made of rubber, chemicals, fabric and steel or other materials. When mounted on the wheel of a motor vehicle, the tire through its tread provides traction and contains the fluid that sustains the vehicle load.

“Radial” and “radially” mean directions toward or away from the axis of rotation of the tire.

“Sidewall” means that component which comprises a portion of the outside surface of a tire between the tread and the bead.

“SS” refers generally to the “serial side” of the tire, that is, the side having the serial number embossed on the sidewall. This notation is used with the notation “NSS” to distinguish the sides of the tire due to its inherent symmetry.

“Tire industry standard size” refers to the series of letters and numbers used by tire manufacturers to define a tire's characteristics. The series includes such factors as vehicle type, tire width, aspect ratio (height to width), radial/bias type, rim diameter, and speed rating, and load rating.

“Tread” means a molded rubber component which when, bonded to a tire casing, includes that portion of the tire that comes into contact with the road when the tire is normally inflated and under normal load.

“Tread Width or Tread Arc Width” means the arc length of the road-contacting tread surface in the axial direction, that is, in a plane parallel to the axis of rotation of the tire.

### BRIEF DESCRIPTION OF DRAWINGS

FIG. 1 is a perspective view of a prior art bus tire;

FIG. 2 illustrates a footprint shape of the tire of FIG. 1 and a corresponding graph of the pressure exerted upon the tread across its width;

FIG. 3 is a cross-sectional view of a tire according to a preferred embodiment of the present invention;

FIG. 4 is a view of a section of the tread of a tire according to a preferred embodiment of the present invention;

FIG. 5 is a diagram defining the footprint shape factor of a tire;

FIG. 6 is a diagram defining the drop off factor of a tire; and

FIG. 7 illustrates a footprint shape of a tire according to a preferred embodiment of the present invention and a corresponding graph of the pressure exerted upon the tread across its width.

### DESCRIPTION OF THE PREFERRED EMBODIMENT(S)

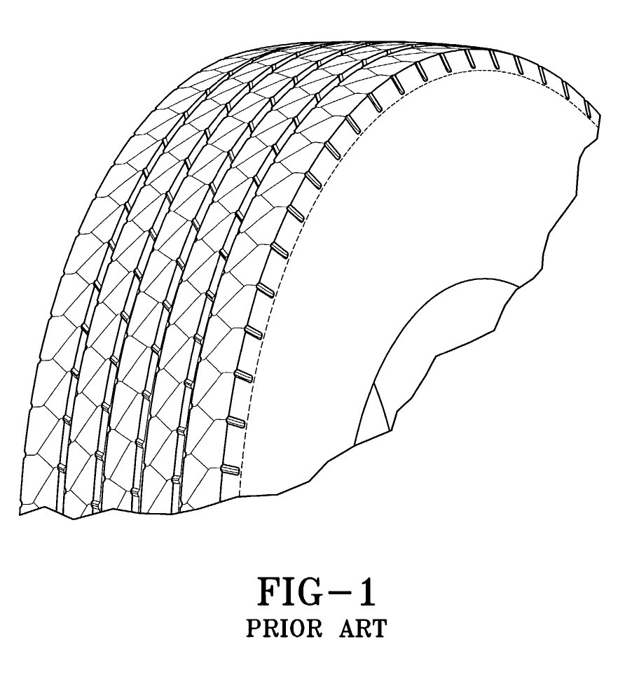

With reference to FIG. 1, a prior art tire is shown. The tire is intended for highway usage on inter-city buses and motor coaches. Such tires typically utilize a stiffer tread compound and increased wearable rubber volume in order to increase the durability of the tire. Durability is an important feature for tires used on these types of vehicles, as they regularly travel many miles over a relatively short period of time.

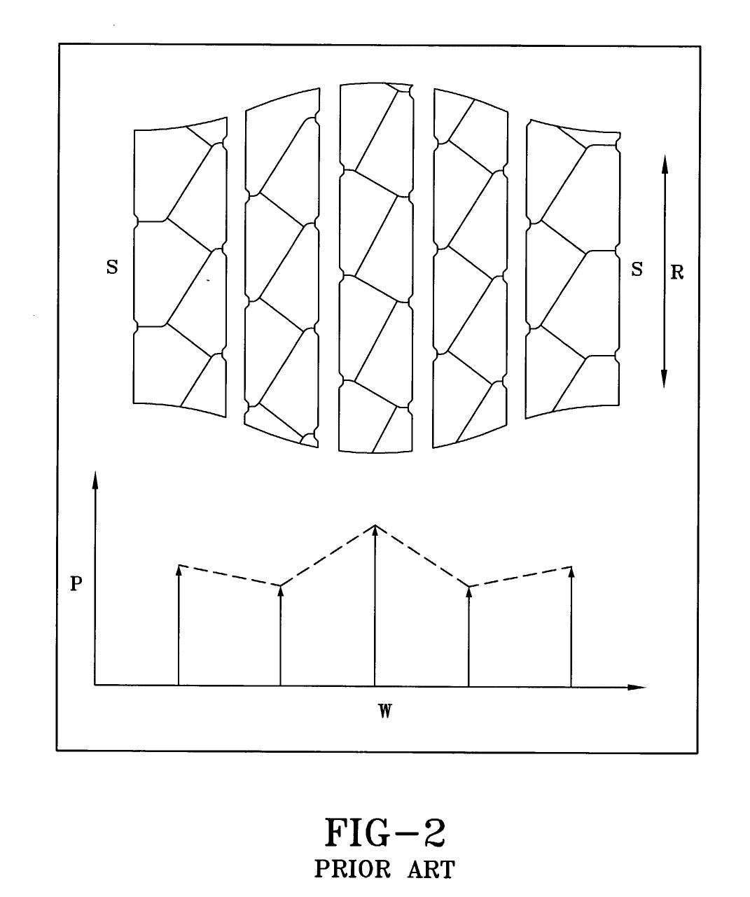

A footprint for the tire of FIG. 1 is shown in FIG. 2. “R” refers to the direction of the tire's rotation and “S” refers to the portion of the footprint imprinted by the shoulder region of the tire. As can be seen in the accompanying graph, the pressure “P” imposed upon the tread of the prior art tire varies across the width “W” of the footprint, being higher at the center, decreasing near the shoulder region “S” of the tire, then increasing again at the outer portion of the shoulder. These concentrations of pressure can result in heat buildup, uneven tread wear, reduced tread endurance, and reduced tire life in the belt edge and shoulder regions.

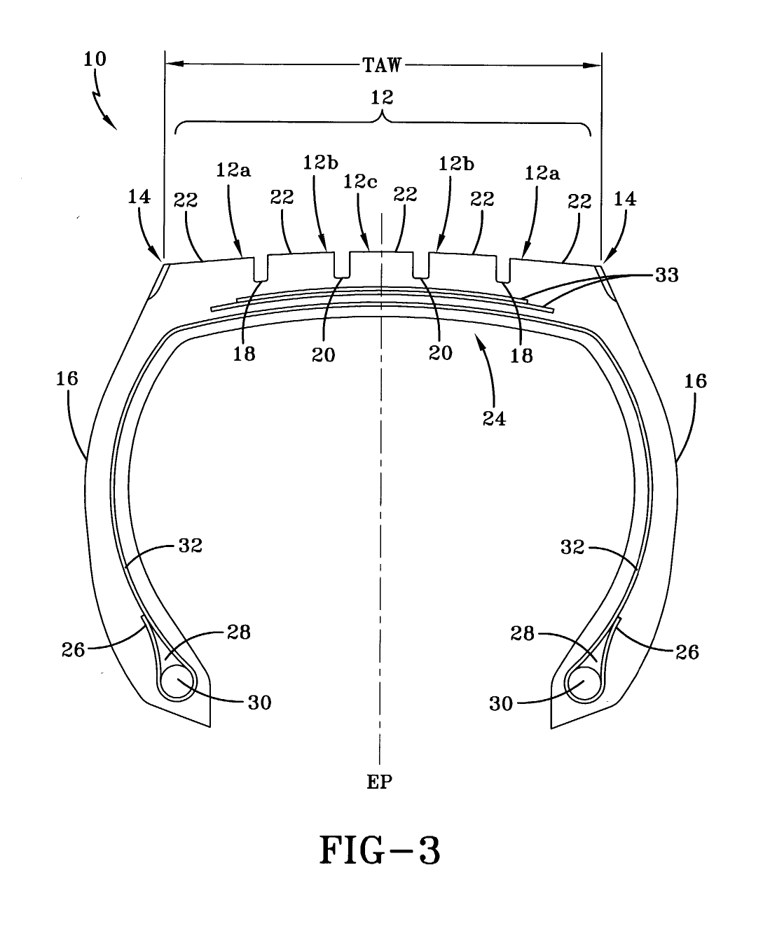

FIG. 3 shows a cross-sectional view of a tire according to an embodiment of the present invention. A tire 10 has a tread portion 12 positioned in a crown area of the tire. A pair of sidewalls 16 are connected to the tread portion by shoulder regions 14. The tread portion 12 has two shoulder circumferential grooves 18 and two center circumferential grooves 20 which divide the tread into five tread portions: two shoulder portions 12a, two intermediate portions 12b, and a center portion 12c. Each tread portion is comprised of a plurality of lugs 22.

With reference again to FIG. 3, a carcass 24 of the tire may comprise a turn-up ply 26 and a high apex 28 to improve the stiffness of the tire sidewall 16. The tire may have one or more reinforcing plies 33. The tire has a pair of substantially parallel annular beads 30 around which is wrapped carcass ply 32. Apex 28 is sandwiched between the main body of the carcass ply 32 and its turn-up ply 26. Sidewalls 16 are disposed over carcass ply 32 in the area of the tire between beads 30 and tread 12. FIG. 3 also illustrates the equatorial plane (“EP”) and the tread arc width (“TAW”) of the tire 10.

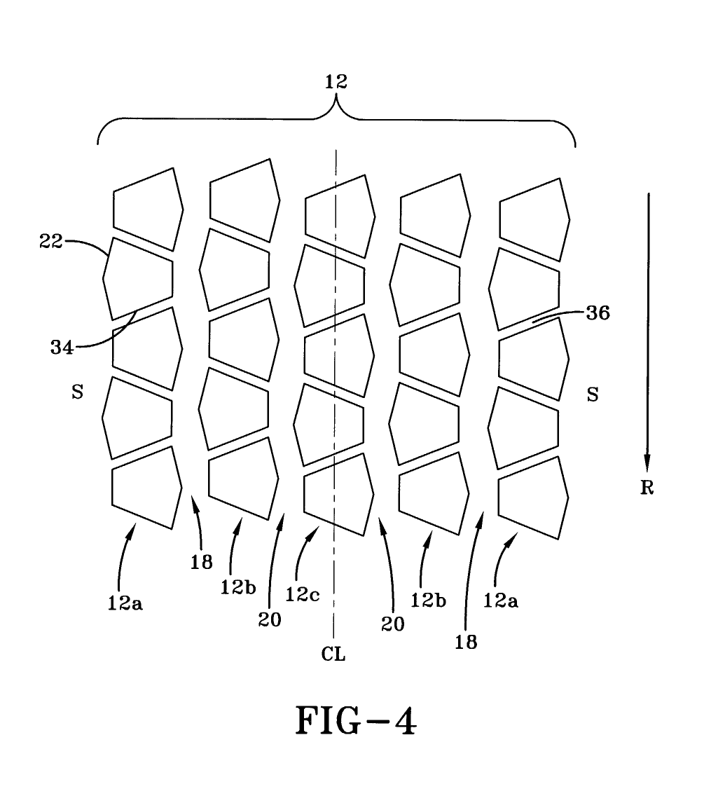

With reference now to FIG. 4, a tread portion 12 according to an embodiment of the present invention is illustrated. Shoulder circumferential grooves 18 and center circumferential grooves 20 divide the tread 12 into five tread portions: two shoulder portions 12a, two intermediate portions 12b, and a center portion 12c. Each tread portion is comprised of a plurality of lugs 22. The lugs are formed by the intersection of the circumferential grooves 18,20 and a plurality of lateral grooves 36. The depth of the tread 12 is defined by the depth of the circumferential grooves 18,20 and lateral grooves 36. The grooves 18,20,36 may be of varying depth in the tire. For example, the lateral grooves 36 may be at a substantially full tread depth of 19/32 inches in the shoulder region of the tire, and graded to a lesser depth of 18/32 inches at the centerline of the tread. For a given direction of rotation “R,” a leading edge 34 for achieving traction may be defined for the lugs 22.

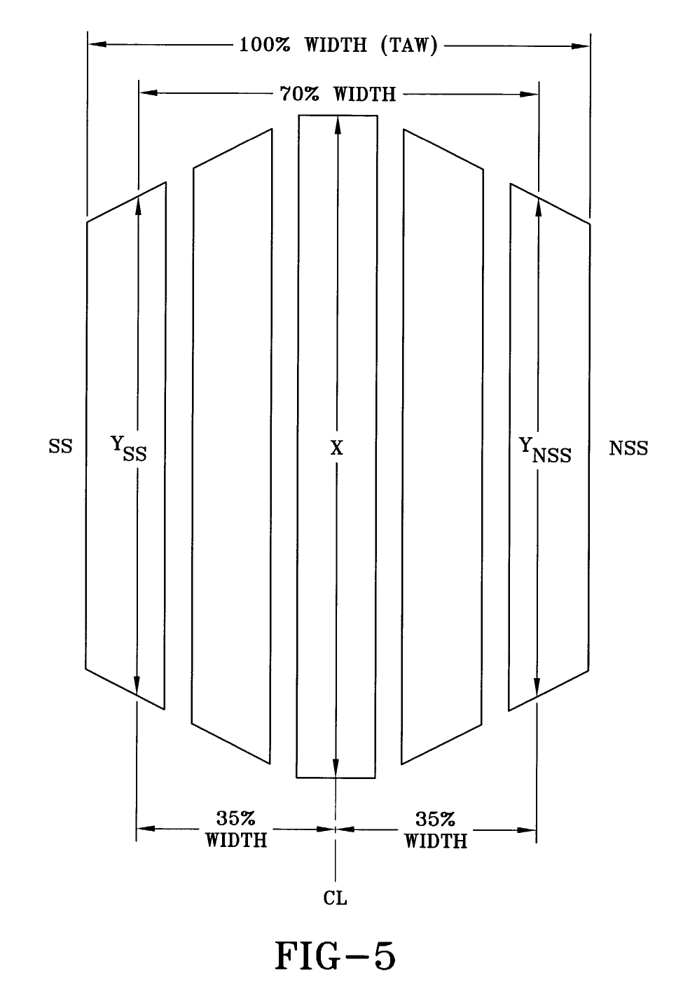

The present invention incorporates a specified footprint shape factor range. As shown in FIG. 5, the footprint shape factor (“FSF”) of a tire is defined by the ratio of the circumferential length “X” of the footprint at its centerline “CL” and the circumferential length Y_{SS} or Y_{NSS} of the footprint, as shown in the following equations:

$${FSF}_{SS} = \frac{X}{{Y}_{SS}} \qquad and \qquad {FSF}_{NSS} = \frac{X}{{Y}_{NSS}}$$

Y_{SS} and Y_{NSS} are located 35% of the distance from the CL to the sides SS and NSS respectively. The FSF of the tire may be measured with reference to either side SS or side NSS. The overall FSF may be calculated by averaging together FSF_{SS} and FSF_{NSS}. The values for FSF_{SS} and FSF_{NSS} may also be examined separately to determine footprint symmetry. Tires made according to the present invention are considered to have an FSF within the specified range if either FSF_{SS} or FSF_{NSS} are within the specified range.

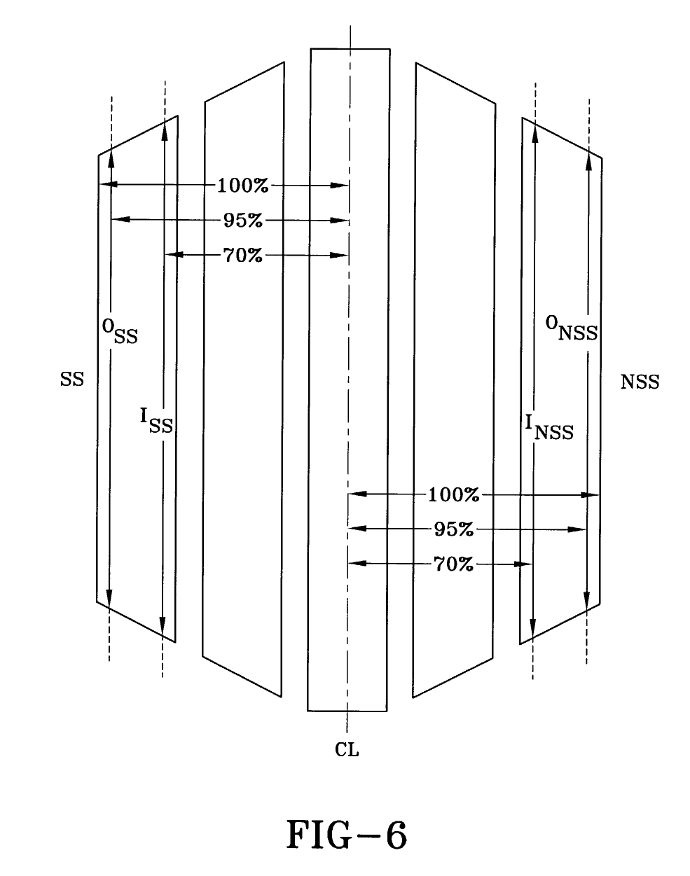

The present invention also incorporates a specified drop off factor range. The drop off factor (“DOF”) of a tire is defined by the ratio of the circumferential length “I” of the footprint and the circumferential length “O” of the footprint, as depicted in FIG. 6 and shown in the following equations:

$${DOF}_{SS} = \frac{{I}_{SS}}{{O}_{SS}} \qquad {DOF}_{NSS} = \frac{{I}_{NSS}}{{O}_{NSS}}$$

Circumferential lengths I_{SS} and I_{NSS} are measured at 70% of the distance from the centerline “CL” of the tire to the sides SS and NSS respectively. Circumferential lengths O_{SS} and O_{NSS} are measured at 95% of the distance from CL to the sides SS and NSS respectively. The DOF of the tire may be measured with reference to either side SS or side NSS. The overall DOF may be calculated by averaging together DOF_{SS} and DOF_{NSS}. The values for DOF_{SS} and DOF_{NSS} may also be examined separately to determine footprint symmetry. Tires made according to the present invention are considered to have a DOF within the specified range if either DOF_{SS} or DOF_{NSS} are within the specified range.

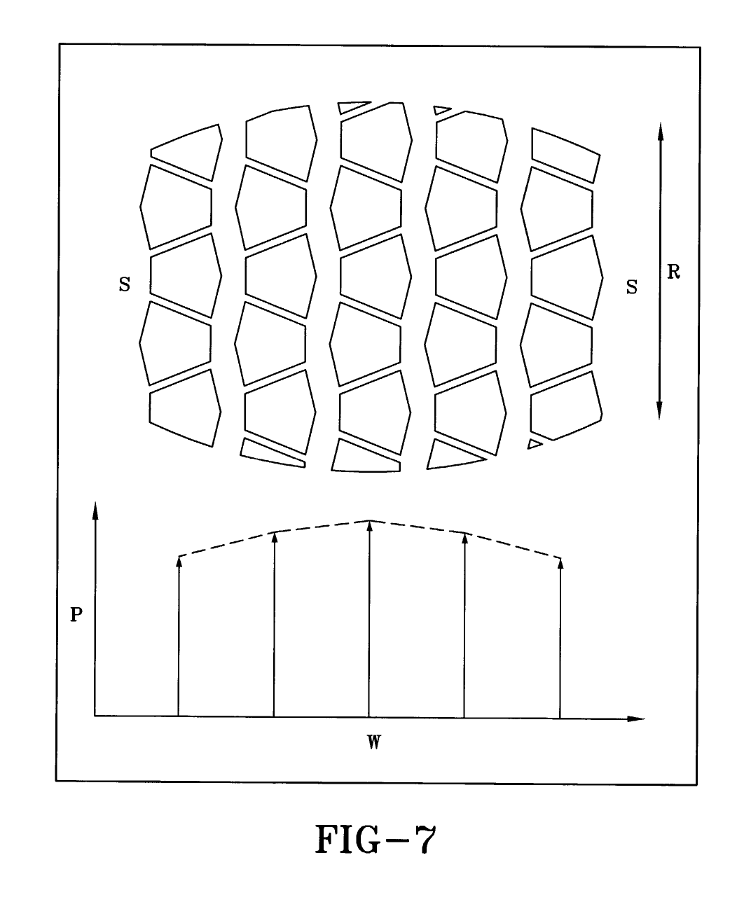

To improve the durability of the tire, a high tread arc width (TAW) in the range of 9.6-9.9 inches is used in combination with a specified footprint shape factor and drop off factor to provide a more even distribution of pressure across the width of the tread. In particular, a footprint shape factor (FSF) in the range of 1.13-1.15 and a drop-off factor (DOF) in the range of 1.10-1.20 are preferred. This combination of TAW, FSF, and DOF produces a tire having a footprint shape similar to that illustrated in FIG. 7. As can be seen, the footprint of the present invention is more rounded as compared to the prior art footprint illustrated in FIG. 2. As shown in the accompanying graph in FIG. 7, the pressure “P” imposed upon the tread of the tire experiences less variation across the width “W” of the footprint, providing reduced tread wear. In particular, pressure concentrations as shown in FIG. 2 near the outer portion of the shoulder regions “S” are eliminated.

The invention is further illustrated with reference to the following example:

### EXAMPLE

A size 315/80R22.5 tire according to an embodiment of the present invention, designated “C1,” is compared to a prior art “Control” tire designed for highway usage on inter-city buses and motor coaches. As is well known in the art, the “315” in the above size designation connotes the section width in mm, “80” is the tire aspect ratio (section height divided by section width), “R” connotes a radial ply tire, and “22.5” is rim bead seat design diameter in inches. The control tire in this example has a design inflation range from 80-120 psi with a corresponding dual-tire load range of 5675-7610 lbs and a single-tire load range of 6175-8270 lbs. The metrics of the comparison are illustrated in Table 1.

TABLE 1

| | Units | Control | C1 |
|---|---|---|---|
| Tread Arc Width (TAW) | Inches | 9.82 | 9.75 |
| Footprint Shape Factor (FSF) | — | 1.18 | 1.14 |
| Drop Off Factor (DOF) | — | 1.00 | 1.15 |

It should also be noted that variations in the design of the tread may be incorporated as desired, so long as the TAW, FSF, and DOF are as taught herein. The tread rubber may be prepared as is conventional in the art using conventional accelerators and initiators. A higher stiffness rubber having greater wear resistance may optionally be selected, if desired.

Those skilled in the art will recognize that other circumferential reinforcement, including conventional steel belts with overlays, as well as other suitable constructions, may be used in the tire construction of the invention.

What is claimed is:

1. A pneumatic tire for inter-city buses or motor coaches, comprising:
a pair of sidewalls;
a pair of shoulder portions;
a carcass;
at least a pair of annular beads;
at least one carcass ply wrapped around said beads;
a tread disposed over said carcass ply in a crown area of said tire, said tread having lugs formed by the intersection of lateral grooves and circumferential grooves, the improvement comprising a tread having a tread arc width in the range of about 9.6-9.9 inches, a footprint shape factor in the range of about 1.13-1.15, and a drop off factor in the range of about 1.10-1.20, wherein the tread comprises a center lug portion, intermediate lug portions disposed on either side of the center lug portion, and shoulder lug portions defined by a tread edge and an edge of an intermediate lug portion.

2. The tire of claim 1 wherein the lateral grooves are at substantially full tread depth in the shoulder portion of the tire and are graded to less than full tread depth at the center portion of the tire.

3. The tire of claim 2 wherein the depth of the tread is about 18/32 inches at a centerline of the tread and is graded to a depth of about 19/32 inches at the shoulder portions.

4. The tire of claim 1 wherein the tire is a tire industry standard size 315/80R22.5.
